(19) United States
(12) Patent Application Publication
(10) Pub. No.: US 2016/0047332 A1
(43) Pub. Date: Feb. 18, 2016

(54) CYLINDER HEAD HAVING IGNITION PLUG WALL AND COOLING CAVITY

(71) Applicant: General Electric Company, Schenectady, NY (US)

(72) Inventors: Julian Knudsen, Waukesha, WI (US); Robert Earl McDowell, Waukesha, WI (US)

(21) Appl. No.: 14/459,943

(22) Filed: Aug. 14, 2014

(51) Int. Cl. F02F 1/24; F02F 1/26

(52) U.S. Cl. CPC F02F 1/242; F02F 1/26

(57) ABSTRACT

A system a cylinder head for a reciprocating engine. The cylinder head includes an ignition plug wall surrounding a bore configured to receive an ignition plug, where the ignition plug wall is integral to the cylinder head, the bore has a diameter, and the ignition plug wall has a thickness. The cylinder head also includes a cooling cavity completely separated from the bore via the ignition plug wall, where the cooling cavity has a radial width relative to an axis of the bore. The cylinder head further includes at least one of a first ratio of a minimum of the thickness versus a minimum of the diameter less than approximately 0.5 or a second ratio of a minimum of the radial width versus the minimum of the diameter less than approximately 0.5, or a combination thereof.

### BACKGROUND

The subject matter disclosed herein relates to reciprocating engines and, more specifically, to a cylinder head for a reciprocating engine.

A reciprocating engine (e.g., an internal combustion engine such as a diesel engine) combusts fuel with an oxidant (e.g., air) in a combustion chamber to generate hot combustion gases, which in turn drive a piston (e.g., reciprocating piston) within a cylinder. In particular, the hot combustion gases expand and exert a pressure against the piston that linearly moves the position of the piston from a top portion to a bottom portion of the cylinder during an expansion stroke. The piston converts the pressure exerted by the hot combustion gases (and the piston's linear motion) into a rotating motion (e.g., via a connecting rod and a crankshaft coupled to the piston) that drives one or more loads, for example, an electrical generator. A cylinder head is generally at a top of the cylinder, above the piston and other components of the cylinder. The cylinder head may include an opening for an ignition plug (e.g., a spark plug), which is configured to ignite the fuel and oxidant in the combustion chamber. Unfortunately, the ignition plug complicates sealing, cooling, emissions control, structural design, and stress control in the cylinder head.

### BRIEF DESCRIPTION

In one embodiment, a system includes a cylinder head for a reciprocating engine. The cylinder head includes an ignition plug wall surrounding a bore configured to receive an ignition plug, where the ignition plug wall is integral to the cylinder head, the bore has a diameter, and the ignition plug wall has a thickness. The cylinder head also includes a cooling cavity completely separated from the bore via the ignition plug wall, where the cooling cavity has a radial width relative to an axis of the bore. The cylinder head further includes at least one of a first ratio of a minimum of the thickness versus a minimum of the diameter less than approximately 0.5 or a second ratio of a minimum of the radial width versus the minimum of the diameter less than approximately 0.5, or a combination thereof.

In a second embodiment, a system includes a cylinder head for a reciprocating engine. The cylinder head includes an ignition plug wall surrounding a bore configured to receive an ignition plug, where the ignition plug wall is integral to the cylinder head. The cylinder head includes a cooling cavity completely separated from the bore via the ignition plug wall. The cylinder head also includes beams extending through the cooling cavity.

In a third embodiment, a system includes a cylinder head for a reciprocating engine. The cylinder head includes an ignition plug wall surrounding a bore configured to receive an ignition plug, where the ignition plug wall is integral to the cylinder head. Further, the cylinder head includes a cooling cavity completely separated from the bore via the ignition plug wall. Further still, the cylinder head includes at least one cleanout port extending into the cooling cavity, where the at least one cleanout port is disposed at a first radial distance from an axis of the bore. The cylinder head also includes at least one valve receptacle, where the at least one valve receptacle is disposed at a second radial distance from the axis of the bore and the first radial distance is less than the second radial distance.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an engine driven power generation system;

FIG. 2 is a cross-sectional side view of an embodiment of a reciprocating engine having a cylinder;

FIG. 3 is a perspective view of an embodiment of a cylinder head of the reciprocating engine of FIG. 2;

FIG. 4 is a cutaway bottom perspective view of an embodiment of a cylinder head, taken along line 4-4 of FIG. 2, illustrating exhaust and intake paths through the cylinder head;

FIG. 5 is a cross-sectional top view of an embodiment of a cylinder head, taken along line 5-5 of FIG. 2, illustrating a cooling cavity of the cylinder head;

FIG. 6 is a cross-sectional side view of an embodiment of a cylinder head of the reciprocating engine of FIG. 2;

FIG. 7 is a cross-sectional side view of an embodiment of a cylinder head of the reciprocating engine of FIG. 2;

FIG. 8 is a cross-sectional schematic view of a portion of an embodiment of a cylinder head of the reciprocating engine of FIG. 2; and

FIG. 9 is a top schematic view of a portion of an embodiment of a cylinder head of the reciprocating engine of FIG. 2.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems for cooling components of reciprocating engines and, more specifically, a cylinder head of the reciprocating engine. In particular, embodiments of the present disclosure include a reciprocating engine that includes a cylinder and a cylinder head. The cylinder head includes an integral ignition plug sleeve (e.g., as a single structure with the cylinder head) or “ignition plug wall” for receiving an ignition plug (e.g., ignition plug or glow plug) of the reciprocating engine, and a cooling cavity (e.g., a coolant passage such as a water passage) proximate the ignition plug wall for cooling components adjacent the cooling cavity. In other words, the ignition plug wall of the cylinder head may define an opening or bore in which the ignition plug (e.g., ignition plug or glow plug) rests, and a cooling cavity of the cylinder head may be disposed radially outward from the wall or surface defining the bore. In accordance with embodiments of the present disclosure, the integral ignition plug wall (e.g., the wall of the cylinder head defining the bore in which the ignition plug resides) may also define, in conjunction with another wall or surface of the cylinder head, at least a portion of the cooling cavity radially outward from the integral ignition plug wall with respect to a longitudinal axis extending through an inside of the integral ignition plug wall. As such, a fluid (e.g., water) may be routed through the cooling cavity (e.g., water passage) for cooling components of the reciprocating engine adjacent the cooling cavity, e.g., the ignition plug. The fluid may be completely separated from the ignition plug via the ignition plug wall of the cylinder head, which may reduce susceptibility of fluid leaking from the cooling cavity.

Including the integral ignition plug sleeve as set forth above may enable a number of advantages over configurations that include a separate ignition plug sleeve (e.g., a spark plug sleeve separate from, and inserted into, the cylinder head). For example, by incorporating the integral ignition plug wall into the cylinder head (e.g., by casting the wall with the cylinder head), cost and manufacturing difficulties may be substantially reduced, improved stiffness may be provided between the ignition plug and the cylinder head (e.g., by including connectors (e.g., radial connectors) between walls of the cylinder head through the cooling cavity), contaminants (e.g., sand or residual flash) that could potentially gather within the inside of the integral ignition plug wall may be more readily removed, and an improved seal may be provided between the inside of the integral ignition plug wall and the cooling cavity, among other factors. Further, mechanical and thermal stresses may be more readily controlled with a single integral structure (e.g., with the ignition plug wall as opposed to a separate ignition plug sleeve). Further still, the cooling cavity may be more appropriately contoured and may improve fluid flow velocity, which may result in higher heat transfer efficiency.

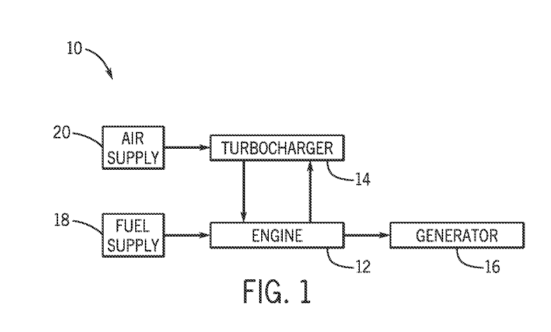

Turning now to the drawings and referring first to FIG. 1, a block diagram of an embodiment of an engine driven power generation system 10 is illustrated. As described in detail below, the disclosed engine driven power system 10 utilizes an engine 12 that includes an improved ignition plug sleeve, where the ignition plug sleeve (e.g., ignition plug wall) is integral with a cylinder head of the engine 12. The integral ignition plug sleeve (e.g., ignition plug wall) may be a spark plug sleeve or a glow plug sleeve. For example, the integral ignition plug sleeve may be an ignition plug wall that is integral with the cylinder head of the engine 12 and defines a bore through which the spark plug extends. The engine 12 may include a reciprocating or piston engine (e.g., internal combustion engine). In certain embodiments, the engine 12 includes a spark-ignition engine or a compression-ignition engine. The engine 12 may include a natural gas engine, diesel engine, or dual fuel engine. The engine 12 may be a two-stroke engine, three-stroke engine, four-stroke engine, five-stroke engine, or six-stroke engine. The engine 12 may also include any number of cylinders (e.g., 1-24 cylinders or any other number of cylinders) and associated piston and liners, where the cylinders and/or the pistons may have a diameter of between approximately 10-30 centimeters (cm), 15-25 cm, or about 22 cm.

The power generation system 10 includes the engine 12, a turbocharger 14, and an electrical generator 16. Depending on the type of engine 12, the engine receives a gas and/or liquid fuel 18 (e.g., diesel, natural gas, syngas, coal seam gases, associated petroleum gas, etc.) or a mixture of both the fuel 18 and a pressurized oxidant 20, such as air, oxygen, oxygen-enriched air, or any combination thereof. Although the following discussion refers to the oxidant as the air 20, any suitable oxidant may be utilized with the disclosed embodiments. The fuel 18 or mixture of fuel 18 and pressurized air 20 is fed into the engine 12. The engine 12 combusts the mixture of fuel 18 and air 20 to generate hot combustion gases, which in turn drive a piston (e.g., reciprocating piston) within a cylinder liner. In particular, the hot combustion gases expand and exert a pressure against the piston that linearly moves the piston from a top portion to a bottom portion of the cylinder liner during an expansion stroke. The piston converts the pressure exerted by the combustion gases (and the piston's linear motion) into a rotating motion (e.g., via a connecting rod and a crankshaft coupled to the piston). The rotation of the crankshaft drives the electrical generator 16 to generate power. In certain embodiments, exhaust from the engine 12 may be provided to the turbocharger 14 and utilized in a compressor portion of the turbocharger 14, thereby driving a turbine of the turbocharger 14, which in turn drives a compressor to pressurize the air 20. In some embodiments, the power generation system 10 may not include all of the components illustrated in FIG. 1. In addition, the power generation system 10 may include other components not shown in FIG. 1 such as control components and/or heat recovery components. In certain embodiments, the turbocharger 14 may be utilized as part of the heat recovery components. Further, the system 10 may generate power ranging from 10 kW to 10 MW. Besides power generation, the system 10 may be utilized in other applications such as those that recover heat and utilize the heat (e.g., combined heat and power applications), combined heat, power, and cooling applications, applications that also recover exhaust components (e.g., carbon dioxide) for further utilization, gas compression applications, and mechanical drive applications.

The power generation system 10 may generate heat due to combustion and linear/rotary motion of parts of the power generation system 10. Accordingly, components of the power generation system 10 may include cooling systems to extract heat from the power generation system 10. For example, the cylinder head of the engine 12, in accordance with present embodiments, may include a cooling cavity at least partially defined by a wall or surface of the cylinder head that also defines an integral ignition plug sleeve of the cylinder head. In other words, the ignition plug may be disposed on one side of the wall and at least a portion of the cooling cavity may be disposed on the other side of the wall. The integral ignition plug wall and cooling cavity, in accordance with the present disclosure, will be described in detail below with reference to later figures.

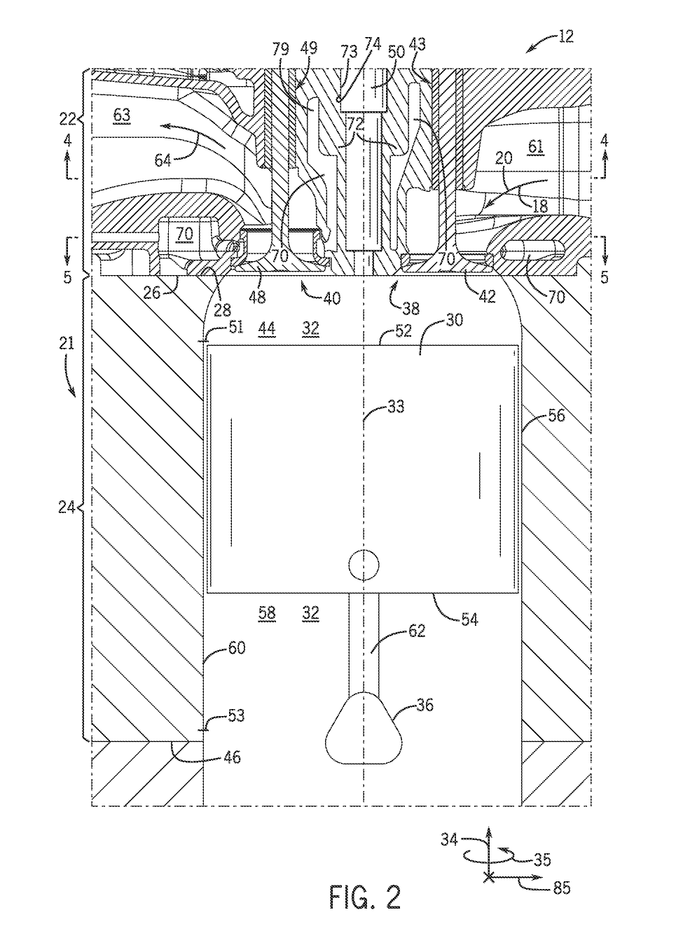

FIG. 2 is a cross-sectional side view of a portion of an embodiment of the reciprocating or piston engine 12 (or, more specifically, a cylinder 21 thereof) having a cylinder head 22 and a cylinder block 24 (or engine block). A bottom surface 26 or plane of the cylinder head 22, in the illustrated embodiment, interfaces with a top surface 28 of the cylinder block 24 (or, depending on the embodiment, a cylinder liner thereof). Further, a piston 30 of the cylinder 21 may be disposed in a cavity 32 within the cylinder block 24 (or cylinder liner thereof), where the piston 30 is centered on a longitudinal axis 33 extending in a longitudinal direction 34 (e.g., axial direction) through the cylinder 21, and the cylinder block 24 and cylinder head 22 extends annularly (e.g., in a circumferential direction 35) about the longitudinal axis 33 a distance away from the longitudinal axis in a radial direction 85. The piston 30 disposed within the cavity 32 may be connected to a crankshaft 36. These components of the cylinder 21 and their respective functions will be discussed in detail below.

In the illustrated embodiment, the cylinder head 22 includes an intake port 38 for receiving fuel 18, air 20, or a mixture of fuel 18 and air 20 and an exhaust port 40 for discharging exhaust from the engine 12. An intake valve 42, disposed within the cylinder head 22 and the intake port 38 and extending through an intake valve opening 43 of the cylinder head 22, opens and closes to regulate the intake of fuel 18, air 20, or the mixture of fuel 18 and air 20 into the engine 12 into a portion 44 of the cavity 32 above the piston 12, where the cavity 32 extends from a bottom 46 of the cylinder block 24 (or cylinder liner thereof) to the top surface 28 of the cylinder block 24 (or cylinder liner thereof) in the longitudinal direction 34. The portion 44 of the cavity 32 may be referred to as a combustion chamber of the cylinder 21. An exhaust valve 48, disposed within the exhaust port 40 and extending through an exhaust valve opening 49 of the cylinder head 22, opens and closes to regulate the discharge of the exhaust from the engine 12. In certain embodiments, an ignition plug 50 extends through a portion of the cylinder head 22 and interfaces with the portion 44 of the cavity 32 where combustion occurs. In a spark-ignition engine embodiment, the ignition plug 50 may be a spark plug. In a compression-ignition engine embodiment (e.g., a diesel engine), the ignition plug 50 may be a glow plug. However, in the following discussion, the ignition plug 50 will be described in the context of a spark plug, although any reference to a spark plug, spark plug wall, etc. is intended to be inclusive of any ignition plug, such as a spark plug or glow plug.

Further, it should be noted that, in some embodiments, the cylinder head 22 may include two intake ports 38 and corresponding intake valves 42 and two exhaust ports 40 and corresponding exhaust valves 48 per cylinder. The cylinder head 22 may be configured to interface with one cylinder or with multiple cylinders, e.g., 2, 3, 4, 5, . . . , 24 cylinders, where each cylinder includes two intake ports and valves 38, 42 and two exhaust ports and valves 40, 48. For example, the two exhaust ports 40 and valves 48 of each cylinder may be disposed approximately 90 degrees away from each other, in the circumferential direction 35, while the two intake ports 38 and valves 42 of each cylinder may also be disposed approximately 90 degrees away from each other. Additionally, the set of exhaust ports 40 and valves 48 may be disposed opposite the set of intake ports 38 and valves 42, such that the exhaust and intake ports 40, 38 and valves 48, 42 form a square, where each is disposed approximately 90 degrees away from the other.

In the illustrated embodiment, the piston 30 (e.g., the cylindrical piston 30 extending annularly in the circumferential direction 35 about the longitudinal axis 33) includes a top surface 52, a bottom surface 54, and a cylindrical side surface 56 extending between the top surface 52 and the bottom surface 54 and extending annularly around the longitudinal axis 33 in circumferential direction 35. The side surface 56 may include rings or some other feature configured to seal the portion 44 (e.g., combustion chamber) of the cavity 32, so that gases do not transfer into a portion 58 of the cavity 32 below the piston 30 and surrounded by the cylinder block 24 (or cylinder liner thereof). The rings or sealing features of the side surface 56 may physically contact and apply a side force against an inner surface 60 of the cylinder block 24 (or cylinder liner disposed within the cylinder block 24) as the piston 30 moves linearly along the longitudinal axis 33, as described below, where the inner surface 60 extends annularly around the piston 30 and the longitudinal axis 33 in the circumferential direction 35.

Opening of the intake valve 42 enables a mixture of fuel 18 and air 20 to flow through an intake path 61 of the cylinder head 22 and enter the portion 44 of the cavity 32 above the piston 30. With both the intake valve 42 and the exhaust valve 48 closed and the piston 30 near top dead center (TDC) (i.e., position of the piston 30 furthest away from the crankshaft 36, e.g., near the top end 28 of the cylinder block 24), combustion of the mixture of air 20 and fuel 18 occurs due to spark ignition via the ignition plug 50 (e.g., a spark plug, while in other embodiments ignition occurs due to compression ignition with or without a glow plug). Hot combustion gases expand and exert a pressure against the piston 30 that linearly moves the position of the piston 30 from a top portion 51 (e.g., at TDC) to a bottom portion 53 of the cylinder block 24 (e.g., at bottom dead center (BDC), which is the position of the piston 30 closest to the crankshaft 36, e.g., near the bottom end 46 of the cylinder block 24) during an expansion stroke, where the cylinder block 24 may include a cylinder liner disposed on its inner surface 60. The piston 30 converts the pressure exerted by the combustion gases (and the piston's linear motion) into a rotating motion (e.g., via connecting rod 62 and the crankshaft 36 coupled to the piston 30 via the connecting rod 62) that drives one or more loads (e.g., the electrical generator 16 in FIG. 1). The exhaust valve 48 then opens and enables exhaust of the combustion gases through the exhaust port 40 and through an exhaust path 63 of the cylinder head 22, as indicated by arrow 64, while the piston 30 moves upwardly toward TDC. As the piston 30 approaches and ultimately reaches approximately TDC, the intake valve 42 opens and enables the fuel 18 and air 20 to enter the portion 44 of the cavity 32 above the piston 30. The portion 44 of the cavity 32 fills with fuel 18 and air 20 as the piston 30 moves downwardly toward BDC. The fuel 18 and air 20 is then compressed as the piston 30 moves upwardly toward TDC. The fuel-air mixture is ignited once the piston 30 reaches approximately TDC, and the process is repeated.

During this process, combustion in the portion 44 of the cavity 32 above the piston 30 generates heat. Further, exhaust exiting the engine 12 or cylinder block 24 thereof may also include heat. It is often desired to cool components of the engine 12 before, during, and/or after combustion. In some configurations, a separate ignition plug sleeve may be disposed or inserted between the cylinder head 22 and the ignition plug 50, and the ignition plug sleeve may serve as a barrier between the cylinder head 22 and the ignition plug 50 while also serving to define a portion of a cavity disposed proximate the ignition plug 50 intended to cool components of the engine 12. However, employing a separate ignition plug sleeve may be costly, may complicate assembly of the cylinder head 22, and may provide a poor sealing of, and may lead to contamination within, a proximate cooling cavity 70 (e.g., as described below), particularly in crevices or connecting points between the ignition plug sleeve and the cylinder head 22 exposed to the proximate cooling cavity 70. Such contamination may lead to blockages in the cooling cavity 70, which generally includes a fluid circulating through the cooling cavity 70 for heat exchange with components of the engine.

Thus, in accordance with present embodiments, the cooling cavity 70 (e.g., a coolant passage such as a water passage) is disposed proximate the ignition plug 50, and the ignition plug 50 does not include a separate ignition plug sleeve. For example, the cylinder head 22 includes the cooling cavity 70 proximate the ignition plug 50, where a wall 72 (e.g., an ignition plug wall integrally formed as one piece with the cylinder head 22) of the cooling cavity 70 (or water passage) completely separates (e.g., completely isolates) the ignition plug 50 from the cooling cavity 70. The wall 72 may be referred to as an ignition plug wall, an integral ignition plug sleeve, or an ignition plug isolator. For simplicity of discussion, the plug 50 and the wall 72 may be identified with reference to a spark plug and corresponding elements, but are intended to cover a spark plug and a glow plug configuration. The wall 72 of the cooling cavity 70 serves as an integral ignition plug sleeve for enabling a barrier between the ignition plug 50 and the cooling cavity 70, such that a separate ignition plug sleeve is not necessary. In other words, an inner surface 73 of the wall 72, in the illustrated embodiment, physically contacts an outer surface 74 of the ignition plug 50. Accordingly, integrating the wall 72 with the cylinder head 22 (e.g., as one piece) enables a more robust cylinder head 22 over configurations with separate sleeves, thereby enabling an efficient assembly of the cylinder head 22, reducing a total cost of producing all the various parts of the cylinder 22, and providing an enhanced seal between the cooling cavity 70 and the ignition plug 50. Further, without a separate ignition plug sleeve, residual material (e.g., flash, sand, etc.) in the cooling cavity 70 may be less likely to deposit in or on crevices between the separate ignition plug sleeve and the cylinder head 22. Further, including the wall 72 as opposed to a separate ignition plug sleeve may facilitate easier cleaning of the cooling cavity 70 when residual materials do conglomerate or gather within the cooling cavity 70. Further, including the wall 72 may enable a more appropriately contoured cooling cavity 70 (e.g., having tapered or restricted flow paths for higher pressure), which may enable a higher fluid flow velocity and better heat transfer efficiency. Further still, including the wall 72 may enable improved stiffness of the cylinder head 22, particularly in portions of the cylinder head 22 proximate the cooling cavity 70. These and other advantages of the wall 72 (e.g., serving as the integral ignition plug sleeve) and other components of the cylinder head 22 will be described in detail below.

In some embodiments, the cooling cavity 70 may extend to areas of the cylinder head 22 away from the ignition plug 50. For example, the cooling cavity 70 may wrap annularly (e.g., in the circumferential direction 35) around the intake port 38, the exhaust port 40, or both, to an area radially (e.g., in a radial direction 85) farther from the ignition plug 50 than the intake and exhaust ports 38, 40. The portion of the cooling cavity 70 proximate the ignition plug 50 may be referred to as an inward portion 79 of the cooling cavity 70.

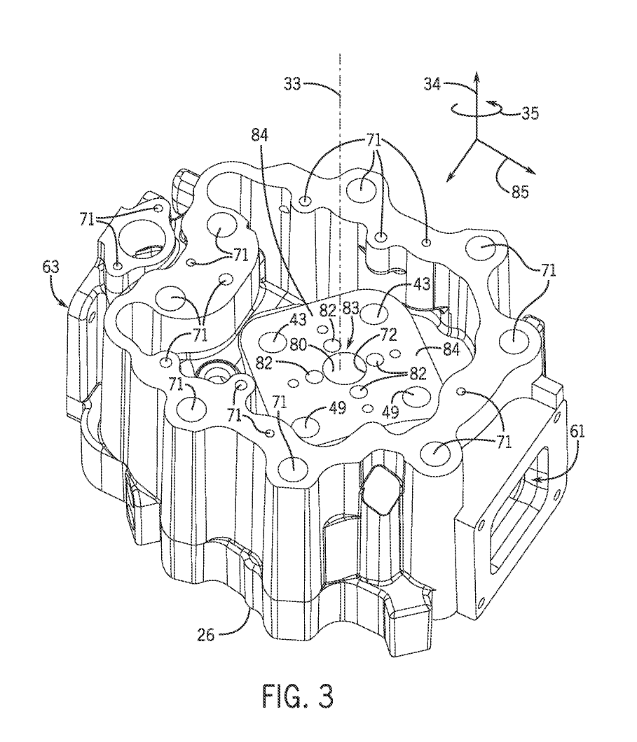

Turning now to FIG. 3, a perspective view of an embodiment of the cylinder head 22 is shown. In the illustrated embodiment, the cylinder head 22 includes a plurality of openings 71. For example, the openings 71 (e.g., fastener openings such as bolt openings) may be utilized to couple the cylinder head 22 to other components of the engine 12, such as a cylinder or block or engine block, a valve cover, conduits, etc. The cylinder head 22 may also include openings 71 for housing or directing components of the engine 12 through the cylinder head 22 for access to internal components of the cylinder head 22 or for access to components adjacent the cylinder head 22. For example, a central opening 80 (e.g., ignition plug opening or bore) is included in the cylinder head 22 for receiving the ignition plug 50. The central opening 80 is defined by the wall 72 (e.g., the ignition plug wall), which serves as a barrier between the ignition plug 50 (See FIG. 2) and the cooling cavity 70 (See FIG. 2) embedded in the cylinder head 22. The central opening 80 may be a substantially cylindrical bore.

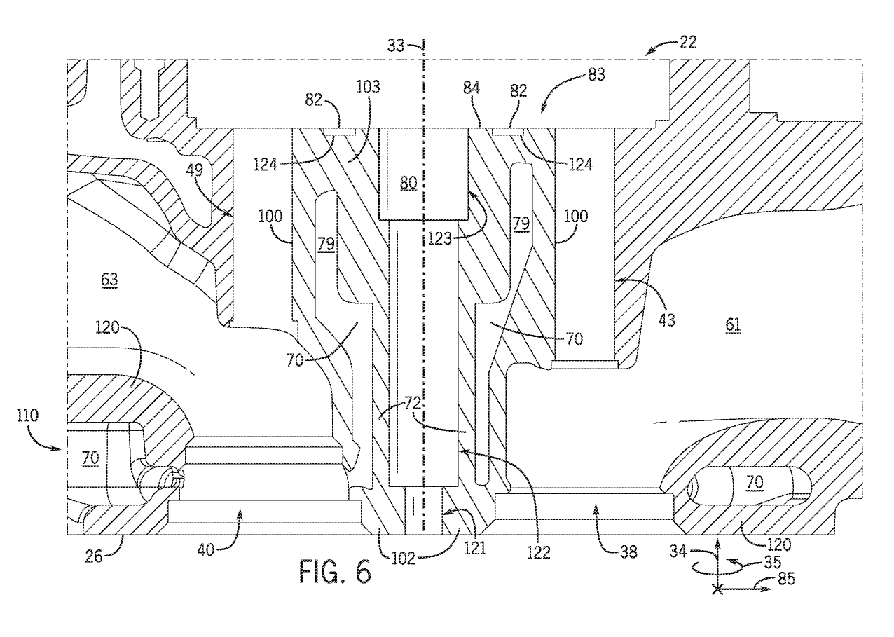

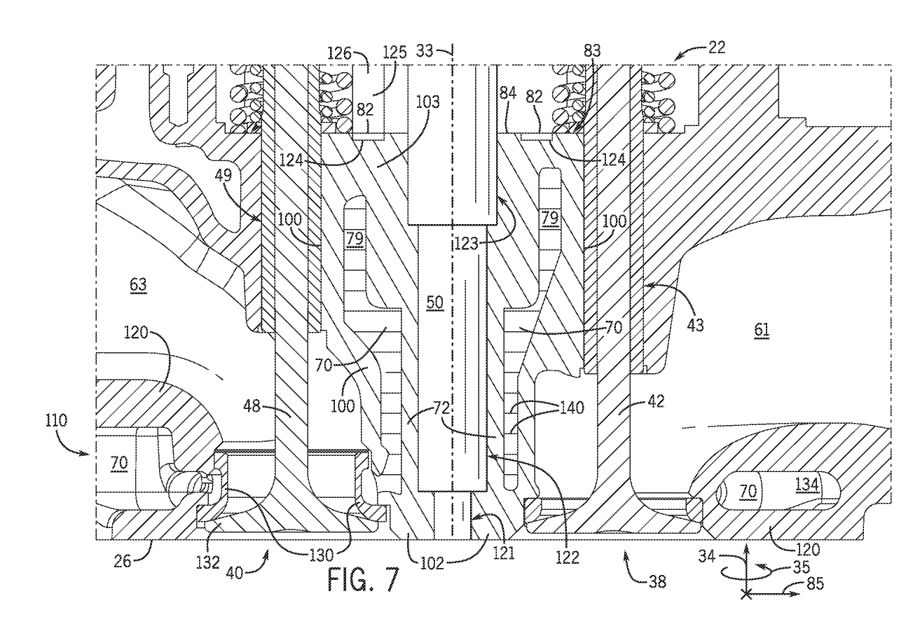

In some embodiments, the central opening 80 may include two or more cylindrical portions (e.g., bores), one on top of the other, each separated by a generally flat surface (e.g., an axially facing ring or annular shoulder) extending in the circumferential direction 35 about the longitudinal axis 33 extending through the central opening 80. These flat surfaces may be included for interfacing with the ignition plug 50, such that the ignition plug 50 may fit into the central opening 80 and surfaces of the ignition plug 50 may rest against the flat surfaces. Put differently, the central opening 80 may include a number of bores, one stacked on top of another, each with different diameters, where the lowest bore (e.g., the bore closest to the bottom surface 26 of the cylinder head 22) has the smallest diameter, and each bore successively increases in diameter upwards from the bottom surface 26. For example, as shown in later figures, the central opening 80 may have a first bore disposed proximate the bottom surface 26, where the first bore includes threads for threadably engaging with threads on the ignition plug 50. Accordingly, the first bore may retain the ignition plug 50 within the central opening 80. Above the first bore, a second bore may be disposed with a second diameter larger than the first diameter of the first bore. Above the second bore, a third bore may be disposed with a third diameter larger than the second diameter of the second bore and the first diameter of the first bore (See FIGS. 6 and 7). The ignition plug 50 may be sized such that it fits into the various bores. This configuration will be described in detail with reference to later figures.

It should be noted that, in some embodiments, the cylinder head 22 may be configured to interface and/or cover more than one cylinder. For example, the cylinder head 22 may interface with 2, 3, 4, 5, . . . , or 24 cylinders, and may include the features shown in the illustrated embodiment for each of the cylinders, or a subset of the cylinders, which the cylinder head 22 interfaces with.

Continuing with the illustrated embodiment, proximate the central opening 80 for the ignition plug 50, four cavity openings 82 (e.g., clean out holes or clean out openings) may be included directly over the cooling cavity 70, where at least the inward portion 79 of the cooling cavity 70 is disposed proximate the central opening 80 (and, thus, the ignition plug 50, when the cylinder head 22 is assembled). In the illustrated embodiment, each of the four cavity openings 82, which may each be referred to as a clean out hole or a clean out opening, is disposed approximately 45 degrees in the circumferential direction 35 away from one of the valve openings 43, 49, and approximately 45 degrees opposite the circumferential direction 35 away from one of the other valve openings 43, 49. In other words, each of the valve openings 43, 49 is disposed proximate one of four corners of a platform 83 of the cylinder head 22, while each of the four cavity openings 82 is disposed approximately 45 degrees away and proximate, albeit more inward (e.g., closer to the central opening 80), sides of the platform 83. However, in another embodiment, each of the four cavity openings 82 may be disposed substantially level with one of the valve openings 43, 49 in the circumferential direction 35.

The four cavity openings 82 may normally be plugged via corresponding plugs (described in detail with reference to later figures), which may be threaded to interface with corresponding threads of the openings 82. In some embodiments, the openings 82 may not include threads, and the plugs may be inserted via other means. For example, the plugs may be press fit or pushed/inserted directly into the openings 82.

The four cavity openings 82 may be included such that a cleaning tool may be inserted into or proximate the inward portion 79 of the cooling cavity 70 for cleaning residual materials deposited in the cooling cavity 70. For example, after normal operation, contaminants (e.g., residual materials, flash materials, sand, etc.) may deposit in portions of the cooling cavity 70, where the deposited contaminants may cause blockage of a coolant being routed through the cooling cavity 70. The contaminants may render cooling of the cylinder head 22 and components adjacent the cylinder head 22 inefficient by blocking water flowing through the cooling cavity 70. Accordingly, the plugs in the cavity openings 82 may be removed, and a cleaning tool may be utilized for extending into or proximate the cavity openings 82 for cleaning the cooling cavity 70 directly below the cavity openings 82. Due to the close proximity of the cavity openings 82, the cooling cavity 70 may be readily cleaned, such that cleaning time/difficulty and/or reassembly time/difficulty may be reduced over configurations with cavity openings 82 disposed farther apart. For example, in context to the illustrated embodiment, configurations utilizing a separate ignition plug sleeve may have irregularly shaped cooling cavities, which are configured to interface at least in part with the separate ignition plug sleeve to define the cooling cavity. Such configurations may necessitate irregularly placed, or widely dispersed, clean out openings above, below, and/or on the side of the cooling cavity.

The cylinder head 22 in the illustrated embodiment also includes two exhaust ports 40 and two intake ports 38 coupled, respectively, to two exhaust valve openings 49 and two intake valve openings 43. The intake valve openings 43 and the exhaust valve openings 49 are disposed outward from the cavity openings 82, as the cooling cavity 70 may, at least in part, be disposed in an area between the central opening 80 and the valve openings 43, 49 (e.g., the inward portion 79 of the cooling cavity 70) relative to the radial direction 85 extending outward from the longitudinal axis 33. In certain embodiments, portions of the cooling cavity 70 may also be disposed radially outward from the valve openings 43, 49 or ports 38, 40 and wrap around the ports 38, 40, and that other clean out openings with corresponding plugs may be disposed over, below, or to the side of those outward portions of the cooling cavity 70 for cleaning those outward portions. In this way, certain portions of the cooling cavity 70 may be disposed below (e.g., relative to the top surface 84 of the platform 83) the intake path 61, which supplies air 20 and fuel 18 through the intake port 38, and below the exhaust path 63, which facilitates exhaust of combustion products through the exhaust port 40 to an exhaust pipe outside of the cylinder head 22. Further, the cooling cavity 70 may be separated from the intake and exhaust paths 61, 63 via a wall or walls of the cylinder head 22, which will be shown and described with reference to later figures. In other words, the intake path 61 and the exhaust path 63 may be disposed on a substantially equal level, while portions of the cooling cavity 70 are disposed below, and separated from, the level of the intake path 61 and the exhaust path 63. However, portions of the cooling cavity 70 proximate the central opening 80 (e.g., the inward portion 79 of the cooling cavity 70) may extend upwardly in direction 34 toward the top surface 84 of the platform 83, such that the inward portion 79 of the cooling cavity 70 proximate the central opening 80 is at least in part on a substantially equal level as the intake and exhaust paths 61, 63, but still separated from the paths 61, 63 via a wall or walls of the cylinder head 22. This configuration, including the cooling cavity 70 and the intake and exhaust paths 61, 63, will be shown and described in greater detail below, with reference to later figures.

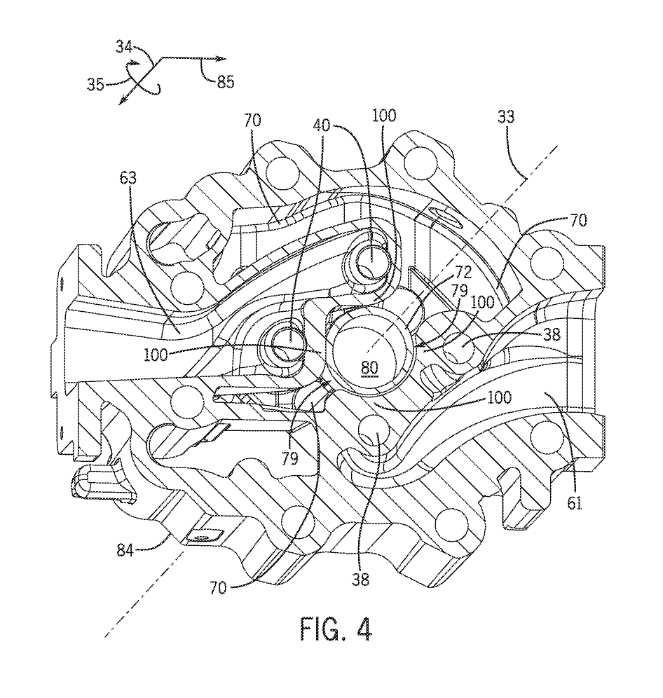

Turning now to FIG. 4, a cutaway bottom perspective view of a cylinder head 22 is shown, taken along line 4-4 in FIG. 2. In the illustrated embodiment, the cylinder head 22 is shown having the intake path 61 and the exhaust path 63. The intake path 61 is coupled to both intake ports 38 and the exhaust path 63 is coupled to both exhaust ports 40. Accordingly, when the intake valve 42 (See FIG. 2) opens, the fuel 18 and air 20 mixture enters through the intake path 61 and intake port 38 into the cylinder. Further, when the exhaust valve 48 (See FIG. 2) opens, exhaust is driven out of the cylinder via the piston 30 (See FIG. 2) through the exhaust port 40 and the exhaust path 63. The central opening 80 is also shown and defined by the wall 72 (e.g., ignition plug wall), where the wall 72 defines the inward portion 79 of the cooling cavity 70 proximate the central opening 80. In other words, in the illustrated embodiment, the inward portion 79 of the cooling cavity 70 is at least partially, or wholly, defined between the wall 72 proximate the central opening 80 and other curvilinear walls 100 extending downwardly, proximate the intake and exhaust ports 38, 40, toward the bottom surface 26 (See FIG. 2) of the cylinder head 22 (e.g., opposite direction 34). In other words, the wall 72 (e.g., ignition plug wall) and the curvilinear walls 100 may define two sides of the inward portion 79 of the cooling cavity 70, and a turning wall 102 (see FIGS. 6 and 7) proximate the bottom surface 26 of the cylinder head 22 may couple the wall 72 and the curvilinear walls 100 for defining the cooling cavity 70. An upper turning wall 103 (see FIGS. 6 and 7) may fully enclose the inward portion 79 of the cavity 70. Further, the cooling cavity 70 may wrap around the exhaust/intake ports 40, 38, such that the cooling cavity 70 extends radially outward (e.g., in the radial direction 85) from the central opening 80. All portions of the cooling cavity 70, however, are in fluid communication with each other in certain embodiments. In other words, the cooling cavity 70 is continuously connected in certain embodiments.

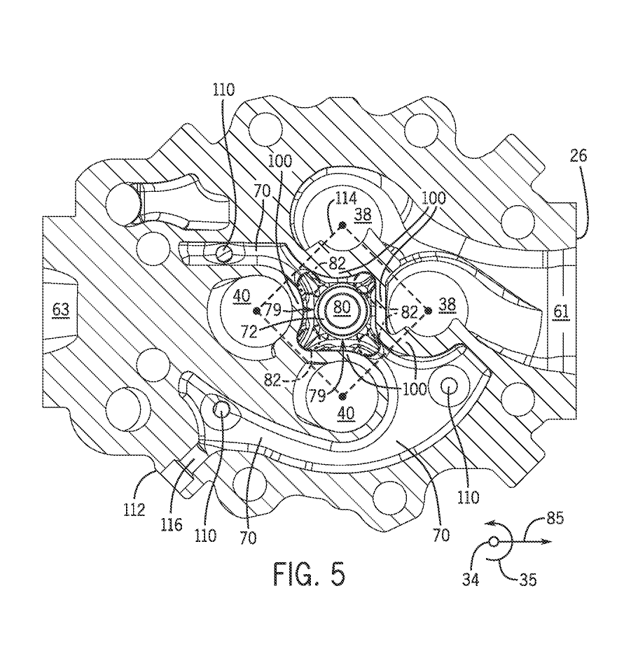

While portions of the cooling cavity 70 may be disposed on a substantially equal level as the intake and exhaust paths 61, 63 (e.g., the inward portion 79, where the “substantially equal level” is on a plane perpendicular to the longitudinal direction 34), other portions of the cooling cavity 70 may be disposed below the intake and exhaust paths 61, 63 (e.g., opposite direction 34). For example, FIG. 5 is a cross-sectional top view of the cylinder head 22 having the inward portion 79 of the cooling cavity 70 proximate the central opening 80, taken along line 5-5 in FIG. 2, where the wall 72 defines a perimeter of the central opening 80 and partially defines a perimeter of the cooling cavity 70 proximate the central opening 80. In other words, the wall 72 proximate the central opening 80 and the curvilinear walls 100 proximate the exhaust ports 38 and intake ports 40 define the inward portion 79 of the cooling cavity 70 proximate the central opening 80. However, the cooling cavity 70 may also extend outwardly in the radial direction 85 away from the central opening 80. For example, in the illustrated embodiment, the cooling cavity 70 wraps around and behind the exhaust ports 40, where portions the exhaust path 63 and intake path 61 would be disposed above the illustrated cross-section (See both FIGS. 4 and 5). Indeed, the cooling cavity 70 may have multiple inlets 110 proximate (and extending through) the bottom surface 26 (which, in the illustrated embodiment, is the surface 26 opposite the cross-sectioned surface) of the cylinder head 22. The inlets 110 may receive water (e.g., coolant) routed upwardly from the cylinder block 24 and may feed the water (e.g., coolant) into the cooling cavity 70, such that the water may extract heat from components (e.g., the ignition plug 50) of the cylinder head 22 or components extending through the cylinder head 22. The coolant may travel upwardly through the cooling cavity 70 and may exit the cooling cavity 70 through outlets on a top surface of the cylinder head 22.

The close proximity of the wall 72 and the curvilinear walls 100 may contribute to efficiency of the cylinder head 22. For example, the close proximity may enable a restricted flow path, which may enable a pressure difference between the inward portion 79 of the cooling cavity 70 and other portions of the cooling cavity 70. This may increase flow speed through the inward portion 79, which may be disposed proximate portions of the cylinder head 22 that experience high thermal loading (e.g., portions proximate the ignition plug 50). Further, the slender flow path of the inward portion 79 may enable a focused flow of coolant on the wall 72, which may enable better heat transfer away from the wall 72 and the ignition plug 50.

The close proximity of the wall 72 and the curvilinear walls 100, which define the inward portion 79 of the cooling cavity 70 proximate the central opening 80, may potentially lead to a gathering of contaminants (e.g., sand, flash residue, etc.) in the inward portion 79. In other words, the inward portion 79 of the cooling cavity 70 may be slender and tightly shaped, while other larger portions of the cooling cavity 70 may be smooth and more open. Thus, contaminants may potentially gather in the inward portion 79 of the cooling cavity 70. Accordingly, the four cavity openings 82 (e.g., clean out holes or openings) may be disposed proximate the wall 72 and over the inward portion 79 of the cooling cavity 70 proximate the central opening 80, such that a cleaning tool may access the cooling cavity 70 from above the cooling cavity 70. The four cavity openings 82 are shown in broken lines in the illustrated embodiment as they are actually disposed above the illustrated cross-section. During normal operation, the four cavity openings 82 are plugged (e.g., with threaded or non-threaded plugs) to block leakage of the coolant flowing through the cooling cavity 70. However, during cleaning, one or more of the plugs disposed within the four cavity openings 82 may be removed, such that the cooling cavity 70 may be accessed by a tool from a position external to the cooling cavity 70.

In the illustrated embodiment, the four cavity openings 82 are disposed radially inward from the intake ports 38 and exhaust ports 40 (e.g., in the radial direction 85). Put differently, the four cavity openings 82 are disposed inward from or even with sides of a square 114 (e.g., an “imaginary” square), where the four corners of the square 114 coincide with the centers of the intake and exhaust ports 38, 40, as shown in the illustrated embodiment. The close proximity of the four cavity openings 82 may enable efficient cleaning of the cooling cavity 70 (e.g., the portion of the cooling cavity 70 proximate the central opening 80). For example, in some embodiments, the cooling cavity 70 may be cleaned through the four cavity openings 82 by a single cleaning tool. In some embodiments, the cooling cavity 70 may be cleaned through all four cavity openings 82 at the same time. In some embodiments, the cooling cavity 70 may be cleaned through each of the four cavity openings 82 separately, but each of the four cavity openings 82 may be readily and more efficiently accessible due to their close proximity.

The close proximity of the four cavity openings 82 may be enabled by the fact that the central opening 80 is defined by the wall 72, as opposed to a separate ignition plug sleeve inserted through the central opening 80, where the separate ignition plug sleeve defines a portion of the cooling cavity 70. By utilizing the integrated wall 72 (e.g., one-piece with cylinder head 22), stiffness of the cooling cavity 70 may be enhanced such that the shape of the cooling cavity 70 is less irregular. In contrast to the disclosed embodiments, with a separate ignition plug sleeve or wall, the four cavity openings 82 may need to be disposed farther away from the central opening 80, as the cooling cavity 70 may be shaped irregularly in one location or multiple locations and may require cleaning in other places, and the cylinder head 22 structure itself may not be as strong or stiff with openings 82 disposed radially inward, closer to the central opening 80. Accordingly, the four cavity openings 82 may be closely arranged for ease of cleaning. Further, by reducing the irregularity of the cooling cavity 70, the cylinder head 22 is more robust and may be easier to manufacture and may have a greater expected life.

In addition to the four cavity openings 82, which are disposed above the cooling cavity 70 and plugged during normal operation, one or more other cavity openings 116 may be disposed throughout the cylinder head 22 proximate the cooling cavity 70. For example, other cavity openings 116 may be disposed below the cooling cavity 70 and extend to the bottom surface 26 of the cylinder head 22. This may enable cleaning of portions of the cooling cavity 70 that extend away from the central opening 80. Further, other cavity openings 116 may be disposed on sides of the cooling cavity 70 (as shown in the illustrated embodiment) and may extend through the cylinder head 22 to the outer surface 112 of the cylinder head 22. The other cavity openings 116 may be strategically located such that portions of the cooling cavity 70 that are expected to gather contaminants may be readily cleaned. However, due to the more regular shape of the cooling cavity 70 due to the integrated wall 72, fewer other cavity openings 116 may be required to clean the cooling cavity 70. For example, the cooling cavity 70 in presently contemplated embodiments may be smoother in most areas, may be designed to include pressure differentials proximate areas with some irregularities (e.g., via a thinner, slimmer, or restricted flow path proximate and/or within the inward portion 79), and may enable better (e.g., faster) fluid flow there through. Further, coolant flowing through larger portions of the cooling cavity 70 may be less likely to be blocked by contaminants in the larger portions of the cooling cavity 70, as the flow path may still be large even with minor contamination.

Turning now to FIGS. 6 and 7, cross-sectional side views of embodiments of the cylinder head 22 are shown. In FIG. 6, only the cylinder head 22 is shown. In FIG. 7, the cylinder head 22 is shown with the ignition plug 50 extending through the central opening 80, the intake valve 42 extending through the intake valve opening 43, and the exhaust valve 48 extending through the exhaust valve opening 49. As previously described, in certain embodiments, the cylinder head 22 extends annularly in the circumferential direction 35 about the longitudinal axis 33, and includes two exhaust valves 48 and two intake valves 42. In the illustrated embodiments, as previously described, portions of the cooling cavity 70 are disposed below the intake and exhaust paths 61, 63 (e.g., the paths 61, 63 are disposed above portions of the cooling cavity 70 in direction 34). Indeed, the intake and exhaust paths 61, 63 may be separated from portions of the cooling cavity 70 below the paths 61, 63 via a separating wall or walls 120. In other words, the paths 61, 63 may be substantially disposed above the separating wall 120, and the separating wall 120 may be substantially disposed above portions of the cooling cavity 70. As such, the cooling cavity 70 is sealed relative to the intake and exhaust paths 61, 63, such that fluids within the cooling cavity 70 do not enter the paths 61, 63.

As previously described, the central opening 80 may include a number of bores, one stacked axially on top of another, each with different diameters, where the lowest bore (e.g., the bore closest to the bottom surface 26 of the cylinder head 22) has the smallest diameter, and each bore successively increases in diameter upwards from the bottom surface 26. For example, the wall 72 defining the central opening 80 may have a first bore 121 disposed proximate the bottom surface 26, where the first bore 121 includes threads for threadably engaging with threads on the ignition plug 50. Accordingly, the first bore 121 may retain the ignition plug 50 within the central opening 80. Above the first bore 121, a second bore 122 may be disposed with a second diameter larger than the first diameter of the first bore 121. Above the second bore 122, a third bore 123 may be disposed with a larger diameter than the second diameter of the second bore 122 and the first diameter of the first bore 121. The ignition plug 50 may be sized such that it fits into the various bores of the opening 80 defined by the wall 72.

The wall 72 (e.g., ignition plug wall) extends from the top surface 84 of the platform 83 (of the cylinder head 22) to the bottom surface 26 of the cylinder head 22. The wall 72 also extends annularly in the circumferential direction 35, about the longitudinal axis 33, to define the central opening 80. Additionally, the wall 72 of the cylinder head 22 separates the ignition plug 50 from the inward portion 79 of the cooling cavity 70 proximate the ignition plug 50. In other words, the wall 72 may serve as a cast in or integral ignition plug sleeve of the cylinder head 22 (e.g., one-piece structure having the wall 72 integrally formed with the cylinder head 22), such that a separate piece is not necessary to be used as an ignition plug sleeve. For example, the ignition plug 50 in FIG. 7 is inserted through the cylinder head 22 in the central opening 80, such that the ignition plug 50 directly interfaces with the wall 72 between the ignition plug 50 and the cooling cavity 70. Accordingly, the cooling cavity 70 is sealed from the central opening 80, such that coolant flowing through or disposed in the cooling cavity 70 does not enter the central opening 80.

However, due at least in part to the close proximity of the ignition plug 50 and the inward portion 79 of the cooling cavity 70, in addition to the slender flow path of the inward portion 79, residual material may potentially gather within the inward portion 79 of the cooling cavity 70 in particular. Accordingly, the four cavity openings 82 are disposed above the inward portion 79 of the cooling cavity 70. The four cavity openings 82 in the illustrated embodiments are plugged by corresponding plugs 124 (e.g., threaded plugs), which may be removed for cleaning at certain intervals.

Focusing in particular on FIG. 7, the four cavity openings 82 (e.g., clean out holes) are plugged by the corresponding plugs 124. Further, two of the corresponding plugs 124, disposed circumferentially 180 degrees away from each other along the top surface 84 of the platform 83 of the cylinder head 22, may be coupled with T-shaped cross heads 125, where only the base (e.g., a shaft 126 of the cross head 125) is shown. The other two plugs 124 may not be coupled to anything. Only one of the T-shaped cross heads 125 is shown in the illustrated embodiment due to the cross-sectional view. In other words, the T-shaped cross head 125 shown in the illustrated embodiment is disposed approximately 45 degrees from the exhaust valve 48 opposite the circumferential direction 35. The other T-shaped cross head 125 is not shown (due to the cross-section), but is disposed approximately 180 degrees away from the illustrated cross head 125 in the circumferential direction 35.

The T-shaped cross heads 125 are included to assist linear motion of the intake and exhaust valves 42, 48 through the intake and exhaust ports 38, 40. For example, a collar (not shown) of the illustrated T-shaped cross head 125 may be disposed around the shaft 126 of the T-shaped cross head 125 near a top of the T-shaped cross head 125. The collar may form the “T,” and the collar may be configured to move up and down the shaft 126 without moving the shaft 126. Either side of the T-shaped collar (e.g., of the illustrated cross head 125) of the cross head 125 may be coupled to both of the exhaust valves 48, such that the collar presses the exhaust valves 48 down as the collar moves down the shaft 126 of the cross head 125. The collar may be actuated up and down the shaft 126 for opening and closing the exhaust ports via an actuator (not shown), where the actuator may be offset due to manufacturing arrangements and may impart a cross wise component to the force exerted on the collar. The shaft 126 is configured to absorb the cross wise component, such that the collar moves up and down the shaft 126 and opens and closes the exhaust ports 40. An actuator (not shown) may push against the T-shaped collar of the cross head 125 to transfer linear motion to the exhaust valves 48 as the collar moves down the shaft 126. The cross heads 125 may be removable, in a similar manner as the regular plugs 124 disposed in the other two cavity openings 83. Indeed, in some embodiments, the cross heads 125 may be coupled to two plugs 124, while in other embodiments, the cross heads 125 may themselves serve as the plugs 124 for the cavity openings 83 above the inward portion 79 of the cooling cavity 70. In any case, the cross heads 125 extend upwardly in direction 34 above the cylinder head 22, such that the cross heads 125 and the associated plugs 124 may be easily removed for cleaning of the cooling cavity 70. Further, in addition to the cross heads 125, the exhaust valves 48, the intake valves 42, and an extension 127 of the ignition plug 50 (e.g., where the extension 127 fits at least partially into the third bore 123 of the central opening 80) may extend upwardly from the cylinder head 22, such that each may be easily removed from the cylinder head 22 assembly.

Continuing with the illustrated embodiment, the exhaust and intake valves 48, 42 may be selectively sealed and unsealed in the exhaust and intake ports 40, 38 during operation of the engine 12. For example, the exhaust valve 48 is shown interfacing with a seal ring 130 disposed around a valve plug or stopper 132 of the exhaust valve 48. The seal ring 130 may interface with the stopper 132, such that the exhaust path 63 is sealed from the cylinder below the cylinder head 22. Of course, the stopper 132 may pushed downward, opposite direction 34, as previously described, for enabling exhaust to exit through the exhaust port 40 and the exhaust path 63.

The seal ring 130 may also seal the cooling cavity 70 from the exhaust port 40. For example, in the illustrated embodiment, coolant may be routed into the cooling cavity 70 through the inlet(s) 110. The coolant (e.g., water) may then flow around the seal ring 130 and into the inward portion 79 of the cooling cavity 70. In this way, the coolant may flow very close to the exhaust valve 48 and exhaust flowing through the exhaust port 40 when the exhaust port 40 is open. This may enable improved heat extraction of components proximate the seal ring 130. In some embodiments, a similar seal ring may be disposed proximate the intake valve 42 for sealing the intake port 38 from the cooling cavity 70. However, in the illustrated embodiment, the cooling cavity 70 extends annularly (e.g., in the circumferential direction 35) around the intake valve 42 and port 40 and is separated from the intake valve 42 and port 40 by structure of the cylinder head 22 itself. Further, in some embodiments, a portion 134 of the cooling cavity 70 radially outward (e.g., in the radial direction 85) from the intake port 38 may also extend circumferentially around the entire intake/exhaust/ignition plug assembly 140.

Continuing with the illustrated embodiment, the wall 72 and the curvilinear walls 100 are bridged via connectors 140 that extend within the cooling cavity 70, where the wall 72, the curvilinear walls 100, the turning wall(s) 102, and the upper turning wall(s) 103 define at least the inward portion 79 of the cooling cavity 70. Indeed, the connectors 140 may actually be disposed anywhere within the cooling cavity 70. The connectors 140 may provide additional rigidity or stiffness to the cylinder head 22, in particular portions of the cylinder head 22 defining the cooling cavity 70. Further, the connectors 140 may enable improved heat extraction by swirling fluid flowing through the cooling cavity 70. For example, water flowing through the cooling cavity 70 may encounter one or more connectors extending through the cooling cavity 70, such that the water swirls and evenly distributes heat extracted from the cylinder head 22 by the water through the water. Further still, the connectors 140 may enable a heat transfer path from the wall 72, through the connectors 140, to the curvilinear walls 100, to other portions of the cylinder head 22 radially outward from the central opening 80 (e.g., in the radial direction 85). In some embodiments, the connectors 140 may extend in the radial direction 85, the longitudinal direction 34, or any other suitable direction. Some of the connectors 140 may extend in one direction, and others of the connectors 140 may extend in another direction. Connectors 140 extend, for example, in the radial direction 85 within the inward portion 79 of the cooling cavity 70 may offer particular benefits, such as efficient swirling of fluid flowing through the inward portion 79, which may improve heat distribution within the fluid for improved (e.g., even or uniform) heat transfer from the cylinder head 22 to the fluid.

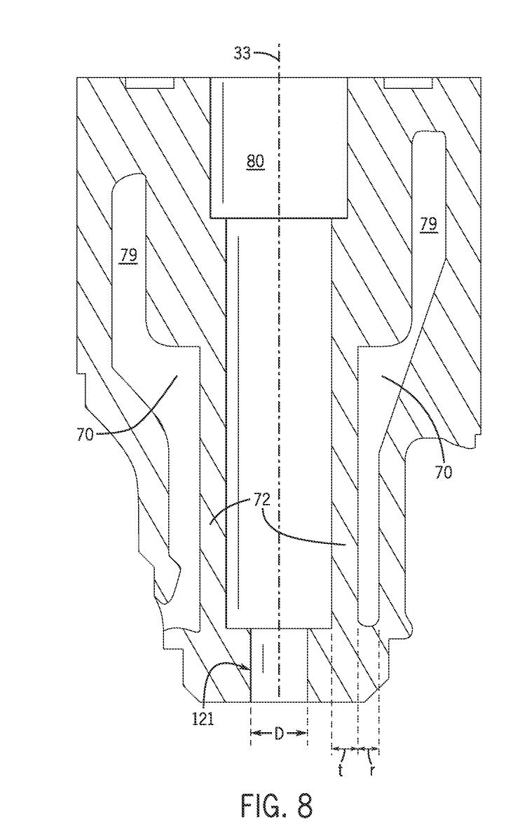

In FIG. 8, a cross-sectional schematic view of a portion of an embodiment of the cylinder head 22 is shown. In particular, the integral ignition plug wall 72, the inward portion 79 of the cooling cavity 70, and the central opening 80 are shown. In the illustrated embodiment, the first bore 121, which may be threaded, has a diameter (D). The integral ignition plug wall 72 has a thickness (t) and the cooling cavity has a radial width (r), with respect to the longitudinal axis 33. The illustrated cylinder head 22 may include a first ratio of a minimum of the thickness (t) versus a minimum of the diameter (D). The first ratio may be in a range of approximately 0.1 to 0.7, approximately 0.2 to 0.6, or approximately 0.3 to 0.5. The illustrated cylinder head 22 may include a second ratio of a minimum of the radial width (r) versus a minimum of the diameter (D). The second ratio may be in a range of approximately 0.1 to 0.7, approximately 0.2 to 0.6, or approximately 0.3 to 0.5. By enabling a thinner cooling cavity 70 (in particular, a thinner inward portion 79 of the cooling cavity 70), fluid pressure of coolant routed through the cooling cavity 70 may be increased, which may enhance heat transfer efficiency to the coolant in the cooling cavity 70. Further, by controlling the thickness (t) of the wall 72, convective heat transfer through the wall 72 may be enhanced and stiffness of the cylinder head 22 may be enhanced.

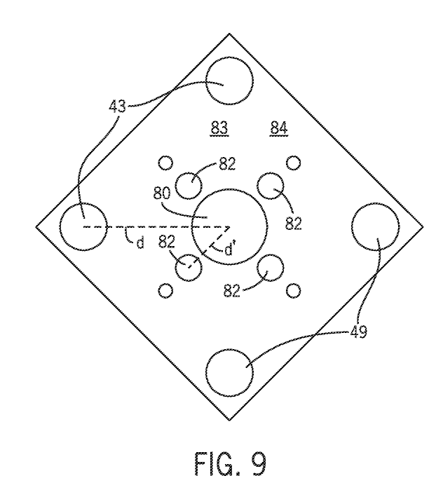

In FIG. 9, a top schematic view of a portion of an embodiment of the cylinder head 22 is shown. In particular, the platform 83 from FIG. 3 is shown. In the illustrated embodiment, each of the valve openings 43, 49 is disposed a first radial distance (d) from a middle of the central opening 80 (e.g., from the axis 33 extending through the central opening 80). Further, each of the cavity openings 82 (e.g., clean out ports or openings) is disposed a second radial distance (d′) from the middle (e.g., the longitudinal axis 33) of the central opening 80. In the illustrated embodiment, the second radial distance (d′) is less than the first radial distance (d). In other words, the cavity openings 82 are closer to the middle (e.g., axis 33) of the central opening 80 than the valve openings 43, 49 (e.g., valve receptacle openings). In some embodiments, one or more of the cavity openings 82 disposed on the top surface 84 of the platform 83 may be disposed closer to the middle of the central openings 80 than the valve openings 43, 49. By disposing the cavity openings 82 closer to the central opening 80, the cooling cavity 70 (in particular, the inward portion 79 of the cooling cavity 70) may be more readily cleaned, as previously described.

The improved cylinder head 22 with the integral ignition plug wall 72 (e.g., one-piece structure with wall 72 integrally formed with head 22), among other features, may improve a seal of the cooling cavity 70 and may promote easier cleaning of the cooling cavity 70. Further, the heat transfer efficiency of the cooling cavity 70 may be enhanced, and the integral ignition plug wall 72 may provide enhanced stiffness to the cylinder head 22 against a side force from the ignition plug 50 or from gas pressure within the cylinder head 22. Further still, the improved cylinder head 22 (e.g., having the integral ignition plug wall 72) may enable a simpler cooling cavity 70 design, such that pollutants are less likely to gather within the cooling cavity 70.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a cylinder head for a reciprocating engine, comprising:
an ignition plug wall surrounding a bore configured to receive an ignition plug, wherein the ignition plug wall is integral to the cylinder head, the bore has a diameter, and the ignition plug wall has a thickness; and
a cooling cavity completely separated from the bore via the ignition plug wall, wherein the cooling cavity has a radial width relative to an axis of the bore;
wherein the cylinder head comprises at least one of:
a first ratio of a minimum of the thickness versus a minimum of the diameter less than approximately 0.5, or
a second ratio of a minimum of the radial width versus the minimum of the diameter less than approximately 0.5,
or a combination thereof.

2. The system of claim 1, wherein the cylinder head has the first ratio less than approximately 0.5.

3. The system of claim 1, wherein the cylinder head has the first ratio less than approximately 0.4.

4. The system of claim 1, wherein the cylinder head has the first ratio less than approximately 0.3.

5. The system of claim 1, wherein the cylinder head has the second ratio less than approximately 0.5.

6. The system of claim 1, wherein the cylinder head has the second ratio less than approximately 0.4.

7. The system of claim 1, wherein the cylinder head has the second ratio less than approximately 0.3.

8. The system of claim 1, wherein the cylinder head comprises at least one cleanout port into the cooling cavity and at least one valve receptacle, the at least one valve receptacle is disposed at a first radial distance from the axis of the bore, the at least one cleanout port is disposed at a second radial distance from the axis of the bore, and the second radial distance is less than the first radial distance.

9. The system of claim 1, wherein the cylinder head comprises a plurality of beams extending through the cooling cavity.

10. The system of claim 9, wherein the plurality of beams comprises a plurality of radial beams extending outwardly from the ignition plug wall to a surrounding wall.

11. The system of claim 9, wherein the plurality of beams comprises at least ten beams.

12. The system of claim 1, comprising the reciprocating engine having the cylinder head.

13. A system, comprising:
a cylinder head for a reciprocating engine, comprising:
an ignition plug wall surrounding a bore configured to receive an ignition plug, wherein the ignition plug wall is integral to the cylinder head;
a cooling cavity completely separated from the bore via the ignition plug wall; and
a plurality of beams extending through the cooling cavity.

14. The system of claim 13, wherein the plurality of beams comprises a plurality of radial beams extending outwardly from the ignition plug wall to a surrounding wall.

15. The system of claim 13, wherein the plurality of beams comprises at least ten beams.

16. The system of claim 13, wherein the plurality of beams are configured to stiffen the ignition plug wall and induce mixing of a coolant fluid flow through the cooling cavity.

17. The system of claim 13, wherein the bore has a diameter, the ignition plug wall has a thickness, and the cooling cavity has a radial width relative to an axis of the bore, wherein the cylinder head comprises at least one of:
a first ratio of a minimum of the thickness versus a minimum of the diameter less than approximately 0.5, or
a second ratio of a minimum of the radial width versus the minimum of the diameter less than approximately 0.5,
or a combination thereof.

18. The system of claim 13, wherein the cylinder head comprises at least one cleanout port into the cooling cavity and at least one valve receptacle, the at least one valve receptacle is disposed at a first radial distance from the axis of the bore, the at least one cleanout port is disposed at a second radial distance from the axis of the bore, and the second radial distance is less than the first radial distance.

19. A system, comprising:
a cylinder head for a reciprocating engine, comprising:
an ignition plug wall surrounding a bore configured to receive an ignition plug, wherein the ignition plug wall is integral to the cylinder head;
a cooling cavity completely separated from the bore via the ignition plug wall;
at least one valve receptacle, wherein the at least one valve receptacle is disposed at a first radial distance from an axis of the bore; and
at least one cleanout port into the cooling cavity, wherein the at least one cleanout port is disposed at a second radial distance from the axis of the bore, and the second radial distance is less than the first radial distance.

20. The system of claim 19, wherein the at least one cleanout port comprises a plurality of cleanout ports, and the at least one valve receptacle comprises at least one intake valve receptacle and at least one exhaust valve receptacle.

21. The system of claim 19, comprising a cross-header coupled to a plug disposed in the at least one cleanout port, wherein the cross-header is coupled to first and second valves disposed in respective first and second valve receptacles of the at least one valve receptacle.
